(19) United States
(12) Patent Application Publication
(10) Pub. No.: US 2008/0022403 A1
(43) Pub. Date: Jan. 24, 2008

(54) METHOD AND APPARATUS FOR A PATTERN MATCHER USING A MULTIPLE SKIP STRUCTURE

(76) Inventors: Tien-Fu Chen, Ming-Hsiung (TW); Chieh-Jen Cheng, Ming-Hsiung (TW)

Correspondence Address: PAI PATENT & TRADEMARK LAW FIRM, 1001 FOURTH AVENUE, SUITE 3200, SEATTLE, WA, 98154, US

(21) Appl. No.: 11/459,349

(22) Filed: Jul. 22, 2006

(51) Int. Cl. G06F 12/14; G06F 11/00; G06F 12/16; G06F 15/18; G08B 23/00

(52) U.S. Cl. 726/23; 726/25

(57) ABSTRACT

A multiple skip structure of a pattern matcher uses a shift engine to read a string and divide the string into a front module and a rear module. The shift engine uses the rear module of the string to index the shift index column of a shift table and retrieves a corresponding shift value and signature value back to the shift engine. The shift engine uses the shift value for the first level of filtering. If the shift value indicates a pattern is contained, it then compares a signature value with a shift hash value for a second level of filtering. The shift hash value is obtained from using the front module of the string via a hash function. If the shift hash value equals to the signature value, then it transmits the position of the string to a trie engine for a full pattern matching.

### FIELD OF INVENTION

The present invention relates to a pattern matcher. More particularly, the present invention relates to a multiple skip structure of a pattern matcher.

### DESCRIPTION OF RELATED ART

A pattern matching is the core of a network intrusion detection system, and nowadays the network intrusion detection system builds the pattern database to store existing patterns. The network intrusion detection system compares strings of the attacking packets with the existing patterns from the pattern database to determine whether the strings contain the pattern. However, network intrusion detection systems spend a considerable amount of time examining every packet with the patterns stored in the pattern database. Therefore a software algorithm and a hardware method are adopted in order to speed up the pattern matching process.

There are generally two types of pattern matching software algorithms that speed up the pattern matching process. The first type, the Finite State Machine (FSM), uses a character as an input unit and requires building a state table containing the possible status of the next character, which uses considerable quantities of memory. The second type is to build a shift table that only contains the shift values to skip through the string if does not contain the pattern. However, if the pattern database contains more than 10,000 patterns then the full pattern matching rate increases significantly.

The pattern matching hardware method can be divided into:

(1) A comparator uses the Filed Programmable Gate Array (FPGA) to provide a renewable pattern environment. The comparator FPGA can handle the information at the rate of 2 gigabits/second. However, the comparator use of the FPGA is restricted due to the capacity of the FPGA and nowadays the FPGA cannot handle all the existing patterns;

(2) A Finite State Machine (FSM) with an Application Specific Integrated Circuit (ASIC) is built. Determination of the next state requires a higher bandwidth to read from a state table. Nowadays, the memory and the FSM are designed on the same chip and use an on-chip bus to provide the required memory bandwidth. However, the forgoing method restricts the capacity of the memory and cannot support the ever increasing number of patterns; and

(3) Content Addressable Memory (CAM) has the advantage of comparing the string with all the patterns in the memory simultaneously. However, the drawback of using CAM is low memory capacity for storing the patterns, higher power consumption and low execution speed.

The software uses an algorithm to provide low complexity and can be executed in the General Purpose Processor (GPP). However, the GPP cannot satisfy network intrusion detection system requirements in super high-speed networks. The hardware pattern matching method cannot handle all the existing patterns, requires higher memory bandwidth, highers cost and higher power consumption. Hence the practical use of the hardware pattern matching method is reduced.

For the forgoing reasons, there is a need to improve the pattern matcher skip structure to provide support for handling all the existing patterns using the preprocessing method in order to reduce the full pattern matching rate.

### SUMMARY

It is therefore an objective of the present invention to provide a multiple skip structure of a pattern matcher.

It is another objective of the present invention to provide an improved preprocessing method for a multiple skip structure.

In accordance with the foregoing objective of the present invention, a multiple skip structure of a pattern matcher uses a shift engine to read a string from a string pump and divides the string into a front module and a rear module. The shift engine uses the rear module of the string to index the shift index column of a shift table in order to read and transmit a corresponding shift value and a signature value to the shift engine. The shift values are generated by a conventional skip value generator to generate the shift values (which is the safe skip value). For example, the skip value generator uses the Wu-Manber algorithm or the hardware that implements Wu-Manber algorithm to compute and store the shift values in the shift table in advance. The signature values use a hash function to compute and store in a signature value column of the shift table in advance.

The shift engine uses the shift value for the first filtering level. If the shift value does not equal to zero, then a position of the string moves towards the right direction of the shift value. If the shift value equals zero, then compare a signature value with a shift hash value for a second filtering level, wherein a shift generator uses the front module to generate the shift hash value.

If the shift hash value equals the signature value, the position of the string moves one character in the right direction. If the shift hash value equals the signature value, then transmits the position of the string to a trie engine.

Therefore the foregoing structure provides a multiple skip structure to fast skip the string does not contain the pattern to lower the rate of the full pattern matching process, and subsequently enhance the matching speed.

In accordance with the foregoing objective of the present invention, a multiple skip structure uses a pre-processing method for pattern matching. First, a trie engine receives a position of a string that requires a full pattern matching process and retrieves the string from a string pump. A trie index generator of the trie engine uses the string to generate a tire hash value and uses the trie hash value to index a trie table, wherein the trie table uses a trie index collision link list method. The trie engine receives a trie node, a current node byte enable, a next node byte enable, a pattern number and a skip value corresponds to a trie index equals to the tire hash value. The trie engine compares the trie node, the current node byte enable, the next node byte enable, the pattern number and the skip value with the string, wherein when the pattern number indicates the presence of another pattern, then the trie engine continues to read the next character of the string; and when the pattern number indicates no other pattern is present, the trie engine continues to read the next string.

The trie node uses a parent node pointer to maintain the relation in a trie tree and stores the pointer in the trie table in advance. The next node byte enable uses the smallest of the current node byte enable of the next node of a trie tree and stores in the trie table in advance. The trie index generator uses a next node byte enable via a hash function to generate the trie hash value.

The pattern number is generated by the logic of the string containing a longer pattern and it then certainly contains a shorter pattern, and stores the pattern number in the trie table in advance. The skip value uses the principle of the pattern and does not generally contain another start point of the pattern, hence the compared string can be skipped and the amount of characters of the compared string is stored as the skip value in the trie table in advance

The foregoing trie table can be stored in the external memory to support the large quantity of the patterns and each trie node uses the parent node pointer to maintain the relation in the trie tree, which takes advantage of only using up one column in the trie table. The skip value provides the skip numbers for the string after the full pattern matching to reduce the repetitive pattern matching.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a structural drawing of a pattern matcher according to an embodiment of the present invention;

FIG. 2 is a flow diagram illustrates a shift engine operation according to one preferred embodiment of this invention;

FIG. 3 is a flow chart illustrates a preprocessing method for a trie table;

FIG. 4 is a diagram of the present invention illustrates using the next node byte enable of the trie node to generate the child node index;

FIG. 5 is a diagram illustrates a L bit of the preferred embodiment of the present invention;

FIG. 6 is a diagram illustrates a skip value of the preferred embodiment of the present invention;

FIG. 7 is a flow diagram illustrates a pattern matching process according to one embodiment of the present invention.

### DESCRIPTION OF THE PREFERRED EMBODIMENTS

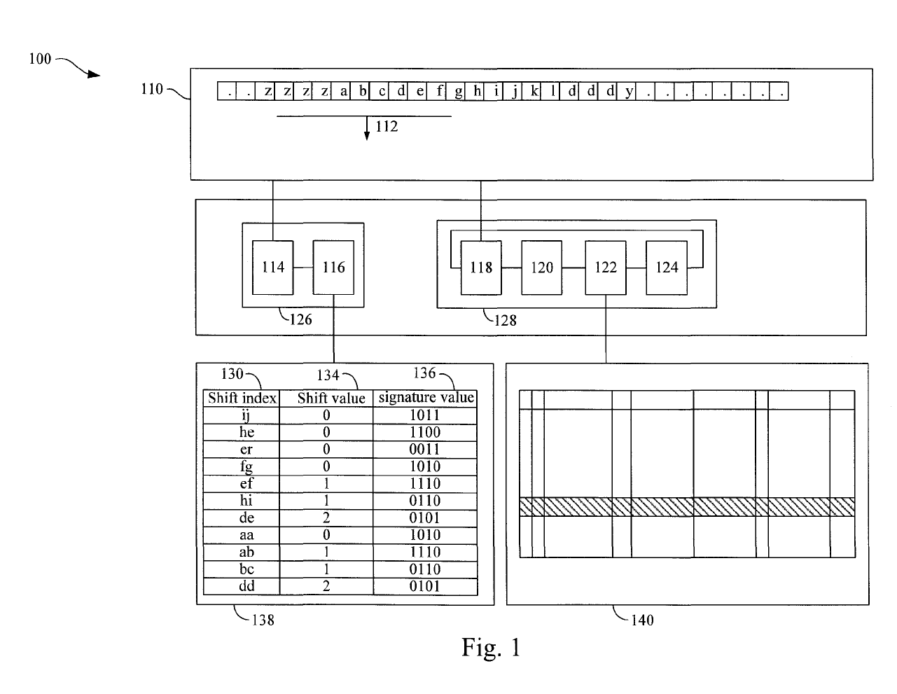

FIG. 1 illustrates a structure drawing of one preferred embodiment of the present invention of a pattern matcher. FIG. 1 illustrates a pattern matcher 100 comprising a shift engine 126 and a trie engine 128, wherein the shift engine 126 and the trie engine 128 uses the pipelines to accomplish a pattern matching task.

The shift engine 126 comprises two pipelines 114 and 116. Pipeline 114 connects to a string pump 110 to read a string 112, and connects and transmits the string 112 to the pipeline 116. The pipeline 116 connects to a shift table 138 to read a shift value 134 and a signature value 136 to decide whether the string 112 contains a pattern, and connects to pipeline 114 to read the next string 112.

The trie engine 128 comprises four pipelines 118, 120, 122 and 124. Pipeline 118 connects to the string pump 110 to read the string 112, and connects to pipeline 120 to transmit the string 112, and connects to pipeline 124 to receive a next position of the string 112. Pipeline 120 is capable of using the string 112 transmitted from pipeline 118 to compute a position of the string 112 in a trie table 140, and connects and transmits the position to pipeline 122. Pipeline 122 connects to the trie table 140 to read the corresponding content of the position in the trie table 140, and connects and transmits the corresponding content to a pipeline 124. Pipeline 124 is capable of computing whether the content of the position in the trie table 140 equals the string 112, and connects to pipeline 118 to read the next string 112.

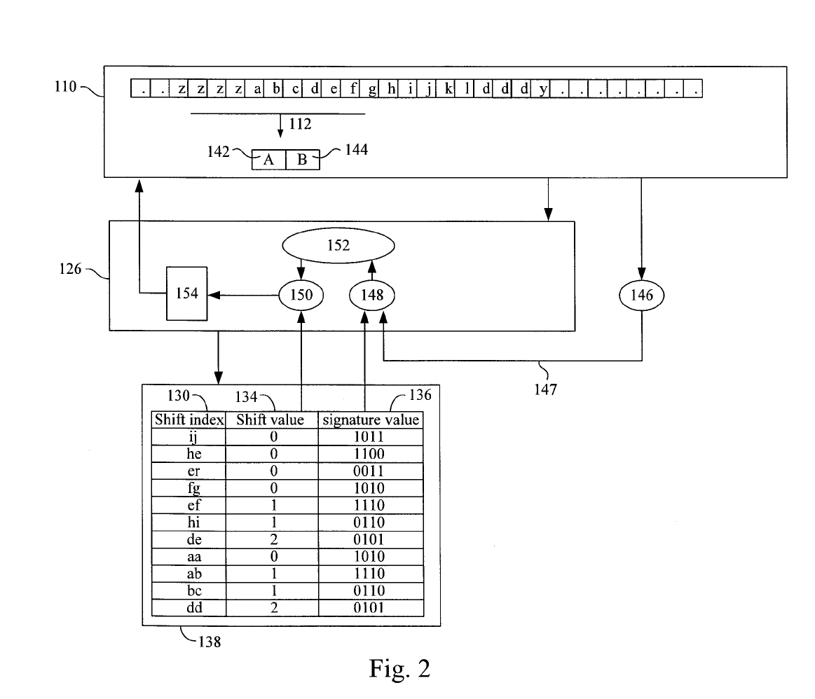

FIG. 2 illustrates a flow diagram of a shift engine operation. The shift engine 126 reads a string 112 from a string pump 110, and the string 112 is divided into a front module 142 and a rear module 144. A shift table 138 contains three columns: shift index 130, shift value 134 and signature value 136. The shift index 130 column stores a plurality of shift indices; the shift value 134 column stores a plurality of shift values; and the signature value 136 column stores a plurality of signature values, wherein each of the shift indices indicate a corresponding shift value and a signature value

The shift table 138 uses a pre-computing method to analyze the existing patterns in order to store the shift values 134 and the signature values 136 in the shift table 138 in advance. The improved shift table 138 has the shift value 134 column with the added signature value 136 column for the present invention. The shift value 134 column uses a conventional skip value generator (not shown) to generate the shift value (which is the safe skip value). For example, using the Wu-Manber algorithm and the hardware that implements the Wu-Manber algorithm to compute and store the shift values in the shift table 138 in advance.

The signature value 136 uses a hash function, which uses the existing pattern to compute and store the corresponding hash values as the signature value in the signature value column 136. The hash function transforms a string of characters into a fixed length (called hash value) that represents the original value. The characteristic of the hash value is when the input is different; consequently the corresponding output (the hash value) is different. In other words, inputting the same string of characters at different times, consequently the outputting hash value is the same.

Referring to FIG. 2, the first level of examination is the shift engine 126 using the rear module 144 of the string 112 as the index to read a corresponding shift value 134 from the shift table 138. When the corresponding shift value 134 is greater than zero, then the position of the string 112 (current string position 154) is shifted in the right direction of the amount of the shift value 134 (which is the safe skip value) by the shifter 150. This can reduce search repetition and hence uses the skip method to search the possible position for the pattern.

When the shift value 134 equals to zero means the rear module 144 of the string 112 might be a pattern, and the shift engine 126 might search out the possible position for the pattern. The search engine 126 then goes through the second level of examination to determine whether to start full pattern matching, which uses the signature value 136 of the present invention to reduce the need of the full pattern matching which will slow down the pattern matching task.

The second level of examination uses a shift generator 146 of the shift engine 126, which uses the front module 142 of the string 112, to generate a shift hash value 147. The shift generator 146 uses a hash function and only generates fixed-length bits (this example is one bit). Then, a comparing unit 148 is used to compare the shift hash value 147 for the front module 142 of the string 112 with the corresponding position of the signature value 136 of the shift table 138.

A comparator 152 is used to compare the shift hash value 147 and the corresponding signature value 136. When the shift hash value 147 equals the corresponding signature value 136, which indicates the string 112 might be a pattern and required to perform the full pattern matching using a trie table 140 (refer to FIG. 1). Otherwise, the current position of the string 112 does not contain the pattern, and then the position of the string 112 is moved one character towards right. The moved position of the string 112 then uses the forgoing steps and divides the string 112 into the front module 142 and the rear module 144 and continues to search out the position that might contain the pattern.

The preferred embodiment of the present invention solves the conventional method that requires wider memory bandwidth (reduce the rate of the full pattern matching), higher misjudge rate (use the signature value to improve the misjudge rate) and the repetition of the pattern matching (use the shift value to skip) to improve the pattern matching task.

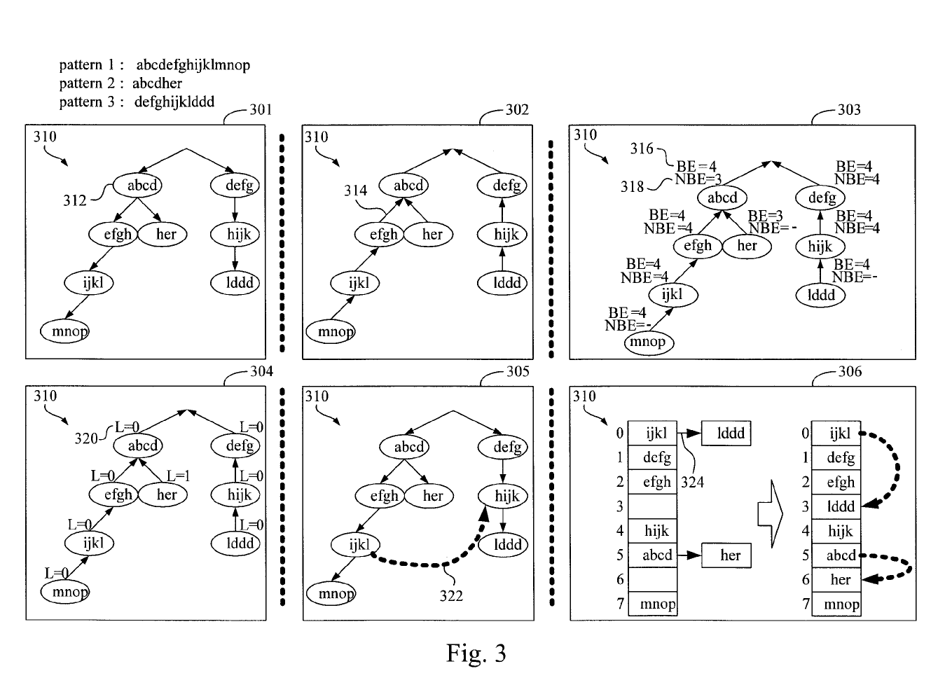

FIG. 3 illustrates a flow of building a trie tree 310. Step 301 uses the existing pattern to build the structure of the trie tree 310. For example, a pattern 1 of FIG. 3 uses 4 characters as a unit for a trie node 312, wherein the pattern 1 is “abcdefghijklmnop”. The “abcd” is the parent node of “efgh”, “efgh” is the parent node of “ijkl”, and “ijkl” is the parent node of “mnop”.

Step 302 of FIG. 3 illustrates the use of a parent node pointer 314 to maintain the relation of each of the trie nodes. For example, a child node “mnop” uses a parent node pointer 314 to maintain the relation with a parent node “ijkl”, a child node “ijkl” uses a parent node pointer 314 to maintain the relation with a parent node “efgh”, a child node “efgh” uses a parent node pointer 314 to maintain the relation with a parent node “abcd”.

The conventional method uses the child node pointers to record each of the trie nodes 312, which requires the several columns to store each of the child node pointers for each of the trie nodes and hence uses a large amount of the memory. The present invention uses the parent node pointers 314 to maintain the trie tree 310, which takes advantage of the characteristic that each trie node 312 has one parent node and hence only uses up one column for each of the tire nodes to store the parent node pointers 314.

Step 303 of FIG. 3 illustrates using a next node byte enable 318 and a current node byte enable 316 of a trie node 312. The next node byte enable 318 is the smallest amount of the characters of the child nodes connected to a parent node (for example, the child nodes “efgh” and “her” connect to the parent node “abcd”, and therefore the next node byte enable for the parent node “abcd” is 3), and the current node byte enable 316 is the amount of characters of the current node (for example, the current node byte enable (BE) 316 of the trie node “abcd” is 4 and the next node byte enable (NBE) 318 is 3 for the trie node “abcd”).

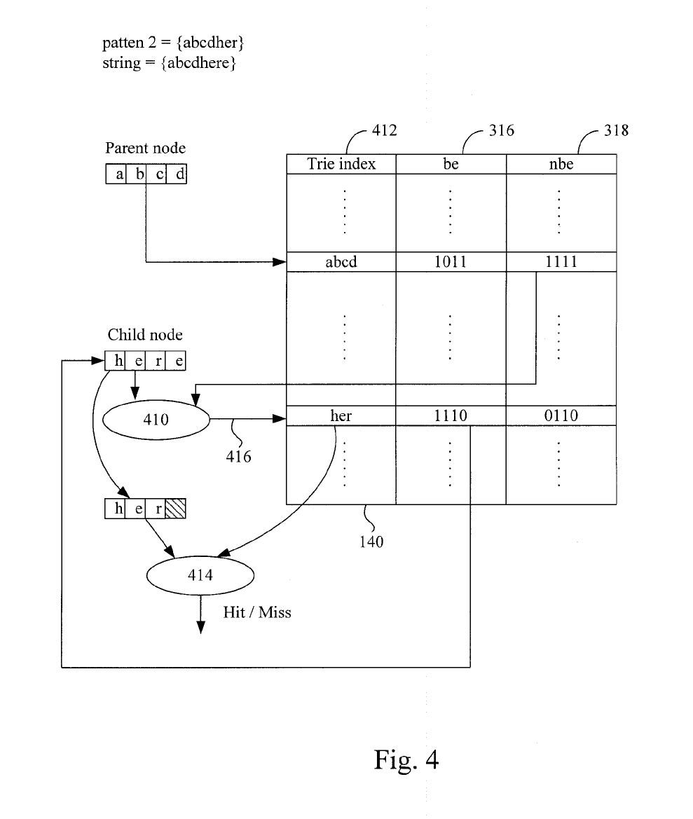

FIG. 4 illustrates a flow diagram of the present invention of using the next node byte enable 318 of the trie node to generate the child node index (the trie index 412 in FIG. 4). The conventional method only uses the current node byte enable 316 to generate the trie index 412 which has the drawback that when the amount of characters at the rear end of the pattern is less than the amount of the characters of the trie node and causes a trie index generator 410 to generate the incorrect trie hash value 416. For example, a pattern 2 is “abcdher” and the example uses four characters for the trie node and stores in the trie index 412. Therefore the pattern parent node is “abcd” and the pattern child node is “her”. This might causes the same trie node to have several different trie hash values 416 when the trie index generator 410 uses the current node byte enable 316 which indicates the amount of characters of the current trie node (For example, “abcd” is 4) instead of the amount of the characters of the next trie node (For example, “her” is 3).

Please refer to FIG. 4, the trie index generator 410 read the next node byte enable 318 (for example, 1111) of a parent node (for example, “abcd”) from the trie table 140 and the child node (for example, “here”) of the string (for example, “abcdhere”), then uses a hash function of the trie index generator 410 to generate the trie hash value 416 to index the trie table 140. The trie comparator unit 414 is then used to determine whether the child node contains the pattern.

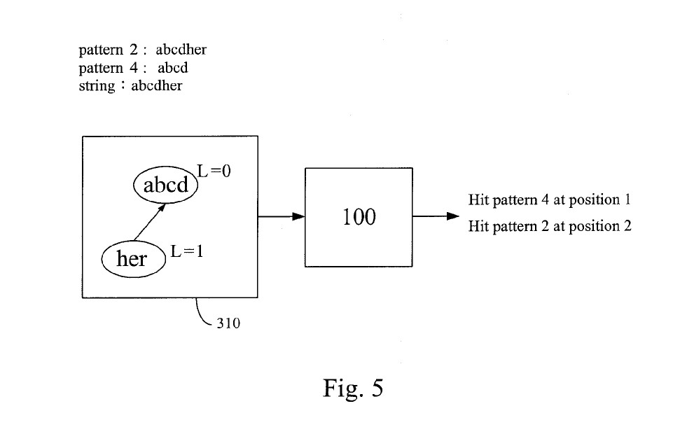

Please refer to step 304 of FIG. 3 and to FIG. 5, which illustrates a diagram of an L bit of the preferred embodiment of the present invention. The basic principle of the L bit is if the pattern A (for example, pattern 2: “abcdher”) contains a pattern B (for example, pattern 4: “abcd”), and then if a string (for example, string: “abcdher”) contains the pattern A surely the string contains the pattern B. If the string contains the pattern B, it however does not mean the string contains the pattern A. Therefore, the trie table 140 (FIG. 1) needs to provide the extra information (L bit) for the trie engine 128 (FIG. 1) to continue to search for the pattern A after the pattern B is found.

Please refer to step 304 of FIG. 3 and FIG. 5, the preferred embodiment uses the L bit 320 (L bit is a pattern number) in the trie node to indicate whether to continue to search for the other pattern when a pattern is found. For example, if the pattern contains the start of another pattern (for example, pattern 4 is the start of pattern 2, which uses L=0 indicates the pattern 4), then the trie engine 128 (FIG. 1) continues to search the other pattern (for example, the rest of the pattern 2, which uses L=1 indicates the pattern 2) in the tire tree 310.

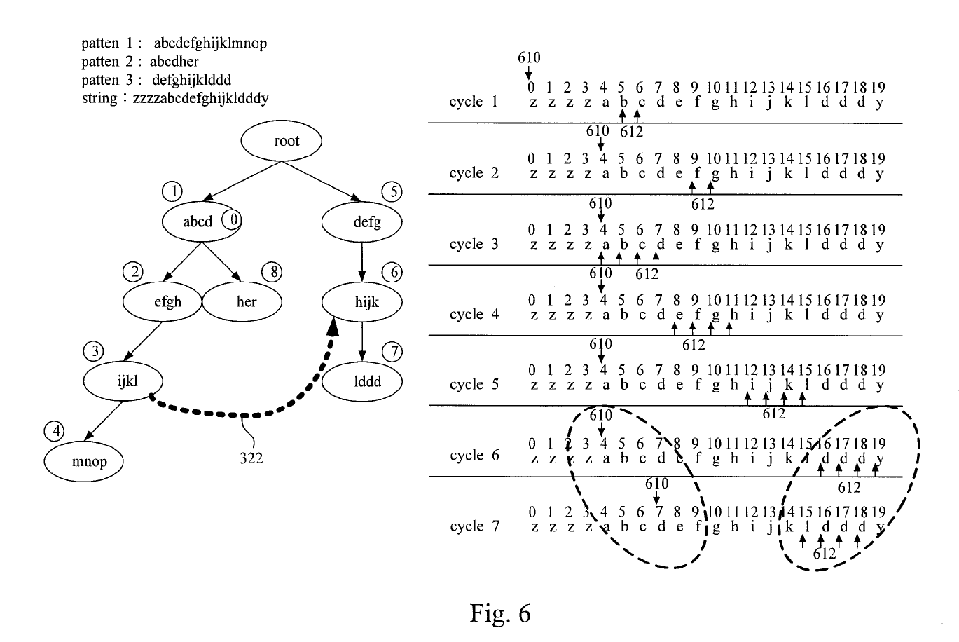

Please refer to step 305 of FIG. 3 and FIG. 6, which illustrates the trie engine used to skip a value 322 to skip the characters and the next start position of the trie engine for the next pattern matching. The present invention uses pattern characteristics and does not generally contain another start point of the other pattern, hence the compared string can be skipped and store the amount of characters of the compared string in the trie table in advance. For example, the trie engine position 612 reads the string during cycle 1 to cycle 5 in order. In cycle 6, if the trie engine 128 (FIG. 1) is required to read the trie nodes from the beginning, then a skip value 322 (skip character mechanism) is used to look for the next pattern to speed up the pattern matching process.

Please refer to step 306 of FIG. 3, which illustrates a method to prevent trie index collision. The trie engine 128 (FIG. 1) uses the hash function to obtain the hash value 416 (FIG. 4) to index the trie index 412 of the trie table 140 (FIG. 4) in order to check whether the string contains the pattern. However, the hash function might generate the same trie index 412 for the different trie node 312 (FIG. 3) and cause several trie nodes 312 to be stored in the same memory space. The present invention uses the link list 324 to connect the trie node 321 having the same trie index and allocates an independent memory space for each of the trie node 312 (For example, the trie node “ijkl” to the trie node “iddd”).

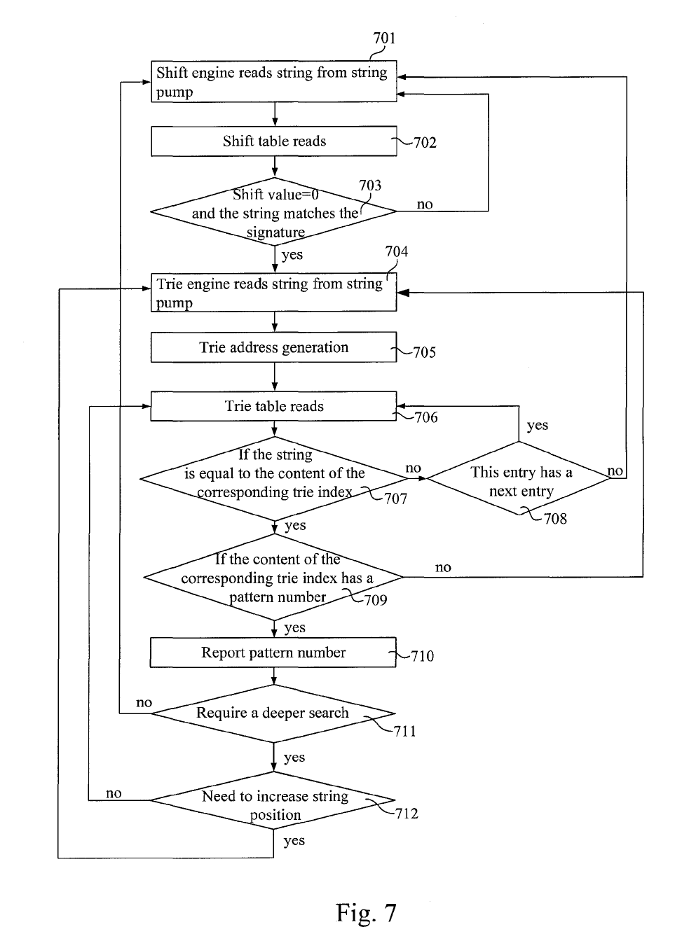

FIG. 7 is the flowchart diagram of the pattern matcher of the preferred embodiment of the present invention. Step 701, step 702 and step 703 as described in FIG. 2, which uses the signature value 136 to reduce the rate of the full pattern matching.

The shift engine 126 transmits a position of the string that might contain the pattern to the trie engine 128. In step 704, the trie engine 128 reads a string 112 from the string pump 110 and in step 705 the trie index generator 410 uses the hash function to generate a trie index 412.

In step 706, read a corresponding content of the trie index 412 from the trie table 140 and in step 707 to compare whether the corresponding content equals to the string 112. If the string 112 is not equal to the content of the corresponding trie index 142 and does not has a next entry (which does not have the next trie node), then the pattern matcher 100 returns to step 701 and adds the skip value 322 to the position of the string 112 (step 708). If the string 112 is not equal to the content of the corresponding trie index 412 and has a next entry (which has the next trie node), then the pattern matcher 100 returns to the step 706 to read the next entry.

If the content of the corresponding trie index equals to the string 112 (step 709) and the content of the trie index 412 does not contain a pattern number 320, then the pattern matcher 100 returns to step 704 to read the next string 112 to continue the trie search. If the content of the trie index 412 contains the pattern number 320, then the pattern matcher 100 has found the string containing the pattern. The pattern matcher 100 reports the pattern number 320 (step 710).

Step 711 uses a pattern number (L bit) 320 to determine whether a deeper search is required. If the pattern number 320 indicates the current trie node does not contain the sub-string, the skip value 322 is then added at the position of the string and returns to step 701 to read the string from the string pump. If the pattern number 320 indicates the current trie node contains the sub-string, then goes to step 712 to determine the position of the string based on a next entry for pattern matching. If the string 112 contains the next entry, then goes to step 706 to read the content of the corresponding trie index of the string, otherwise increase the string position and return to step 701 and read the next string 112 from the string pump 110.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multiple skip structure of a pattern matcher, for network intrusion detection system, comprising:
a string pump capable of reading a string, wherein the string comprises a front module and a rear module;
a shift table comprising a plurality of shift indices, a plurality of shift values and a plurality of signature values, wherein each of the shift indices indicates the corresponding shift value and signature value;
a shift engine connects the string pump and the shift table and is capable of reading and computing the string; and
a trie engine connects to the string pump and a trie table and is capable of a full pattern matching;
wherein the shift engine uses the shift value and the signature value to decide whether to start the trie engine.

2. The multiple skip structure of a pattern matcher of claim 1, further comprising a skip value generator to generate the shift values and store the shift values in the shift table in advance.

3. The multiple skip structure of a pattern matcher of claim 1, wherein the signature values use a hash function to compute and store the result from the has function in the shift table in advance.

4. The multiple skip structure of a pattern matcher of claim 1, wherein a shift generator uses a hash function to compute the front module of the string to generate the shift hash value and compares the shift hash value with the signature value.

5. A method of multiple skip of a pattern matcher for a network intrusion detection system comprises:
reading a string at a shift engine from a string pump;
dividing the string into a front module and a rear module;
comparing the rear module with a plurality of shift indices of a shift table;
transmitting a shift value and a signature value corresponds to a shift index equal to the rear module from the shift table to the shift engine;
computing the shift value in the shift engine;
using the front module of the string via a hash function to generate a shift hash value; and
comparing the shift hash value and the signature value to determine whether to start a trie engine.

6. The method of multiple skip of the pattern matcher of claim 5, further comprising a skip value generator to generator the shift value and store the shift value in the shift table in advance.

7. The method of multiple skip of the pattern matcher of claim 5, wherein the signature value use a hash function to compute and store the result from the hash function in the shift table in advance.

8. The method of multiple skip of the pattern matcher of claim 5, wherein the shift engine computes the shift value further comprises the steps of:
when the shift value does not equal to zero, then a position of the string moves toward right direction of the shift value; and
when the shift value equals to zero, further comprises the steps of:
when the shift hash value does not equal to the signature value, then the position of the string moves one character toward right direction; and
when the shift hash value equals to the signature value, then transmits the position of the string to the trie engine.

9. The method of multiple skip of the pattern matcher of claim 5, wherein the shift hash value is compared with the signature value further comprises:
when the shift hash value does not equal to the signature value, then the position of the string moves one character toward right direction; and
when the shift hash value equals to the signature value, then transmits the position of the string to the trie engine.

10. A method of multiple skip of a pattern matcher, for network intrusion detection system, comprising:
receiving a string at a trie engine from a string pump;
generating a trie hash value uses the string via a trie index generator of the trie engine;
indexing the trie hash value with a plurality of trie indices of a trie table;
transmitting a trie node, a current node byte enable, a next node byte enable, a pattern number and a skip value corresponds to a trie index equals to the trie hash value to the trie engine; and
comparing and computing the trie node, the current node byte enable, the next node byte enable, the pattern number and the skip value with the string.

11. The method of multiple skip of the pattern matcher of claim 10, wherein the trie node, the current node byte enable, the next node byte enable, the pattern number and the skip value are computed and then stored in the trie table in advance.

12. The method of multiple skip of the pattern matcher of claim 10, wherein the trie node, the current node byte enable, the next node byte enable, the pattern number and the skip value use a hash function to compute and store in the trie table in advance.

13. The method of multiple skip of the pattern matcher of claim 12, wherein the trie table uses a trie index collision link list method.

14. The method of multiple skip of the pattern matcher of claim 10, wherein the trie node uses a parent node pointer to maintain the relation in a trie tree and stores in the trie table in advance.

15. The method of multiple skip of the pattern matcher of claim 10, wherein the next node byte enable uses the smallest of the current node byte enable of the next node of a trie tree and stores in the trie table in advance.

16. The method of multiple skip of the pattern matcher of claim 10, wherein the trie index generator uses a hash function to generate the trie hash value.

17. The method of multiple skip of the pattern matcher of claim 16, wherein the trie index generator uses the next node byte enable to generate the trie hash value.

18. The method of multiple skip of the pattern matcher of claim 10, wherein the pattern number is generated by the logic of the string contains a longer pattern then certainly contains a shorter pattern, and stores the pattern number in the trie table in advance.

19. The method of multiple skip of the pattern matcher of claim 18, wherein the trie engine compares the trie node and the string uses the pattern number, comprises the steps of:
when the pattern number indicates another pattern is contained, then the trie engine continues to read the next character of the string; and
when the pattern number indicates another pattern is not contained, then the trie engine continues to read the next string.

20. The method of multiple skip of the pattern matcher of claim 10, wherein the skip value uses the principle of the pattern does not generally contain another start point of the pattern, hence the compared string can be skipped and the amount of characters of the compared string is stored as the skip value in the trie table in advance.
